(19) United States
(12) Patent Application Publication
(10) Pub. No.: US 2009/0136722 A1
(43) Pub. Date: May 28, 2009

(54) WET FORMED FIBROUS STRUCTURE PRODUCT

(76) Inventors: Dinah Achola Nyangiro, Mason, OH (US); Markus Wilhelm Altmann, Wiesbaden (DE); Christopher Clayton Dixon, Loveland, OH (US); Jeffrey Glen Sheehan, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/251,476

(22) Filed: Oct. 15, 2008

Related U.S. Application Data
(60) Provisional application No. 60/990,095, filed on Nov. 26, 2007.

(51) Int. Cl. B32B 3/10; B32B 5/02; B32B 7/02; D21F 11/02; D21H 21/00

(52) U.S. Cl. 428/195.1; 428/219; 428/213; 162/202; 162/158

(57) ABSTRACT

A fibrous structure product having two or more plies, wherein said fibrous structure product also has: (a) a plurality of formed surface features; (b) a Hand Protection Factor of greater than about 2×10⁻²; and (c) a basis weight of less than about 32 lbs/3000 ft².

### CROSS-REFERENCE TO RELATION APPLICATION

This application claims the benefit of provisional U.S. Application No. 60/990,095, filed Nov. 26, 2007.

### FIELD OF THE INVENTION

The present invention relates to wet formed fibrous structured paper products, more specifically wet formed fibrous structure products having increased bulk and thickness which provides a relatively improved user experience.

### BACKGROUND OF THE INVENTION

Fibrous structure products are a staple of everyday life. Fibrous structure products may be used as consumer products for paper towels, toilet tissue, facial tissue, napkins, and the like. The large demand for such paper products has created a demand for improved versions of the products and the methods of their manufacture.

Consumers prefer fibrous structure products having multiple attributes. These attributes or functional qualities include softness, absorbency, strength, flexibility, and bulk. In particular, a product that provides a high level of bulkiness and/or thickness may provide users with positive perceptions of other characteristics such as absorbency and strength. In addition to the improvement in perceived characteristics, a towel which is bulky and/or thick may have physical qualities that provide additional benefits to the user. For example, a bulky paper towel product may have a relatively thick “wall” structure within the features of the paper towel product. It is known in the art to provide a relatively bulky and/or thick paper towel product. However, the prior art methods of providing such a product often rely on the use of additional converting steps or the simple increase of basis weight of the product. Unfortunately, while providing a relatively improved product to the consumer, such methods are often cost prohibitive.

Thus, there exists the need for a method to provide a high bulk, thick, consumer preferred, and soft fibrous structure product that minimizes the additional costs incurred and that does not cause unwanted effects in the final product. Surprisingly, it is found that by altering the microstructure design of the fibrous structure product, it is possible to provide a highly desirable fibrous structure product while keeping costs to a relative minimum. Also surprisingly, it is found that by altering the microstructure design of the fibrous structure product, it is possible to provide a fibrous structure product with a relatively homogeneous fiber distribution throughout the surface features of the product that are formed during the papermaking process. Even more surprising, it is found that by providing such a microstructure, the fibrous structure product may provide a product that distributes liquid preferentially in the MD-CD plane rather than in the z-direction, thus providing consumers with the benefit of having a dry hand longer during use when compared to prior art product, but at the same time being cost-efficient (i.e., not using too much material).

### SUMMARY OF THE INVENTION

In one nonlimiting embodiment, the present invention is directed to a fibrous structure product having two or more plies, wherein said fibrous structure product comprises: (a) a plurality of formed surface features; (b) a Hand Protection Factor of greater than about 2×10⁻²; and (c) a basis weight of less than about 32 lbs/3000 ft².

In a different nonlimiting embodiment, the present invention is directed to a fibrous structure product having one ply, wherein said fibrous structure product comprises: (a) a plurality of formed surface features; (b) a Hand Protection Factor of greater than about 2×10⁻²; and (c) a basis weight of greater than about 16 lbs/3000 ft².

In another nonlimiting embodiment, the present invention is directed to a fibrous structure product having one or more plies, wherein said fibrous structure product comprises: (a) a plurality of formed surface features; and (b) a Resistance Factor of greater than about −0.20.

In yet another nonlimiting embodiment, the present invention is directed to a process for providing a fibrous structure product wherein the process comprises the steps of: (a) providing a slurry wherein the slurry comprises from about 30 percent to about 100 percent by weight of NSK fibers; and wherein the slurry comprises a pulp filtration resistance of from about 20° SR to about 28° SR; and (b) processing the slurry with a conventional through air dried papermaking apparatus, wherein the papermaking apparatus comprises a Fourdrinier wire and a carrier fabric; wherein the Fourdrinier wire is operating at a relatively slower speed than the carrier fabric.

In still another nonlimiting embodiment, the present invention is directed to a fibrous structure product comprising a plurality of formed features, wherein the formed features comprise a pillow region, a knuckle region, and a transition zone; wherein the transition zone comprises a transition zone thickness and wherein the pillow region comprises a pillow region thickness; wherein the transition zone thickness is from about 60 μm to about 120 μm; and wherein the ratio of the transition zone thickness to the pillow region thickness is greater than about 0.8.

### BRIEF DESCRIPTION OF THE DRAWINGS

While the specification concludes with claims that particularly point out and distinctly claim the present invention, it is believed that the present invention will be understood better from the following description of embodiments, taken in conjunction with the accompanying drawings, in which like reference numerals identify identical elements.

FIG. 1 shows a schematic view of an exemplary apparatus for practicing the present invention product.

FIG. 2A shows a top view of an exemplary embodiment of a fibrous structure product having formed features according to the present invention.

FIG. 2B shows a cross-sectional view of the exemplary embodiment of a fibrous structure product of FIG. 2A taken along the line 2B-2B.

FIG. 3A shows a scanning-electron microscope image of the cross-section of an exemplary fibrous structure product of the present invention.

FIG. 3B shows a scanning-electron microscope image of the cross-section of an exemplary fibrous structure product of the prior art.

### DETAILED DESCRIPTION OF THE INVENTION

### Definitions

“Paper product”, as used herein, refers to any formed, fibrous structure products, traditionally, but not necessarily, comprising cellulose fibers. In one embodiment, the paper products of the present invention include tissue-towel paper products.

“Fibrous structure product”, as used herein, refers to products comprising paper tissue or paper towel technology in general, including, but not limited to, conventional felt-pressed or conventional wet-pressed fibrous structure product, pattern densified fibrous structure product, starch substrates, and high bulk, uncompacted fibrous structure product. Non-limiting examples of tissue-towel paper products include disposable or reusable, toweling, facial tissue, bath tissue, table napkins, placemats, wipes, and the like.

“Ply” or “Plies”, as used herein, means an individual fibrous structure or sheet of fibrous structure, optionally to be disposed in a substantially contiguous, face-to-face relationship with other plies, forming a multi-ply fibrous structure. It is also contemplated that a single fibrous structure can effectively form two “plies” or multiple “plies”, for example, by being folded on itself. In one embodiment, the ply has an end use as a tissue-towel paper product. A ply may comprise one or more wet-laid layers, air-laid layers, and/or combinations thereof. If more than one layer is used, it is not necessary for each layer to be made from the same fibrous structure.

Further, the layers may or may not be homogenous within a layer. The actual makeup of a fibrous structure product ply is generally determined by the desired benefits of the final tissue-towel paper product, as would be known to one of skill in the art. The fibrous structure may comprise one or more plies of non-woven materials in addition to the wet-laid and/or air-laid plies.

“Sheet Caliper” or “Caliper”, as used herein, means the macroscopic thickness of a product sample under load.

“Fibrous structure”, as used herein, means an arrangement of fibers produced in any papermaking machine known in the art to create a ply of paper. “Fiber” means an elongate particulate having an apparent length greatly exceeding its apparent width. More specifically, and as used herein, fiber refers to such fibers suitable for a papermaking process. The present invention contemplates the use of a variety of paper making fibers, such as, natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps; mechanical pulps including groundwood, thermomechanical pulp; chemithermomechanical pulp; chemically modified pulps, and the like. Chemical pulps, however, may be preferred in tissue towel embodiments since they are known to those of skill in the art to impart a superior tactical sense of softness to tissue sheets made therefrom. Pulps derived from deciduous trees (hardwood) and/or coniferous trees (softwood) can be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, fibers derived from non-wood pulp such as cotton linters, bagesse, and the like, can be used. Additionally, fibers derived from recycled paper, which may contain any or all of the pulp categories listed above, as well as other non-fibrous materials such as fillers and adhesives used to manufacture the original paper product may be used in the present web. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, lyocell, polyester, polyethylene, and polypropylene fibers can be used within the scope of the present invention. Further, such fibers may be latex bonded. Other materials are also intended to be within the scope of the present invention as long as they do not interfere or counter act any advantage presented by the instant invention.

In addition to the fibers described in the “fibrous structure” section supra, synthetic fibers useful to produce the present invention. Synthetic fibers include any material, such as, but not limited to, those selected from the group consisting of polyesters, polypropylenes, polyethylenes, polyethers, polyamides, polyhydroxyalkanoates, polysaccharides, and combinations thereof. The synthetic fiber may comprise a polymer. The polymer may be any material, such as, but not limited to, those materials selected from the group consisting of polyesters, polyamides, polyhydroxyalkanoates, polysaccharides and combinations thereof. More specifically, the material of the polymer segment may be selected from the group consisting of poly(ethylene terephthalate), poly(butylene terephthalate), poly(1,4-cyclohexylenedimethylene terephthalate), isophthalic acid copolymers (e.g., terephthalate cyclohexylene-dimethylene isophthalate copolymer), ethylene glycol copolymers (e.g., ethylene terephthalate cyclohexylene-dimethylene copolymer), polycaprolactone, poly(hydroxyl ether ester), poly(hydroxyl ether amide), polyesteramide, poly(lactic acid), polyhydroxybutyrate, and combinations thereof.

Further, the synthetic fibers can be a single component (i.e., single synthetic material or mixture makes up entire fiber), bi-component (i.e., the fiber is divided into regions, the regions including two or more different synthetic materials or mixtures thereof and may include co-extruded fibers) and combinations thereof. It is also possible to use bicomponent fibers, or simply bicomponent or sheath polymers. Nonlimiting examples suitable bicomponent fibers are fibers made of copolymers of polyester (polyethylene terephthalate)/polyester (polyethylene terephthalate) (otherwise known as “CoPET/PET” fibers), which are commercially available from Fiber Innovation Technology, Inc., Johnson City, Tenn.

These bicomponent fibers can be used as a component fiber of the structure, and/or they may be present to act as a binder for the other fibers present. Any or all of the synthetic fibers may be treated before, during, or after the process of the present invention to change any desired properties of the fibers. For example, in certain embodiments, it may be desirable to treat the synthetic fibers before or during the papermaking process to make them more hydrophilic, more wettable, etc.

Multicomponent and/or synthetic fibers are further described in U.S. Pat. Nos. 6,746,766 and 6,890,872; U.S. Pat. Pub. Nos. 2003/0077444A1, 2003/0168912A1, 2003/0092343A1, 2002/0168518A1, 2005/0079785A1, 2005/0026529A1, 2004/0154768A1, 2004/0154767, 2004/0154769A1, 2004/0157524A1, and 2005/0201965A1.

“Basis Weight”, as used herein, is the weight per unit area of a sample reported in lbs/3000 ft² or g/m².

“Machine Direction” or “MD”, as used herein, means the direction parallel to the flow of the fibrous structure through the papermaking machine and/or product manufacturing equipment.

“Cross Machine Direction” or “CD”, as used herein, means the direction perpendicular to the machine direction in the same plane of the fibrous structure and/or fibrous structure product comprising the fibrous structure.

“Z-direction,” as used herein, means the direction normal to a plane formed by machine direction and cross machine directions.

“Differential density”, as used herein, means a portion of a fibrous structure product that is characterized by having a relatively high-bulk field of relatively low fiber density and an array of densified zones of relatively high fiber density. The high-bulk field is alternatively characterized as a field of pillow regions. The densified zones are alternatively referred to as knuckle regions. The densified zones may be discretely spaced within the high-bulk field or may be interconnected, either fully or partially, within the high-bulk field. One embodiment of a method of making a differential density fibrous structure and devices used therein are described in U.S. Pat. Nos. 4,529,480 and 4,528,239.

“Densified”, as used herein, means a portion of a formed fibrous structure product that is characterized by zones of relatively high fiber density. The densified zones may be known to those of skill in the art as “knuckle regions.” The densified zones may be discretely spaced within the high-bulk field or may be interconnected, either fully or partially, within the high bulk field.

“Non-densified”, as used herein, means a portion of a formed fibrous structure product that exhibits a lesser density than another portion of the formed fibrous structure product. Non-densified zones may be known to those of skill in the art as “pillow regions.”

“Transition zone”, as used herein, means a portion of a formed fibrous structure product that associates densified areas with non-densified areas. The transition zone may have the same or higher density and/or the same or lower thickness than the non-densified zones and the same or lower density and/or the same or higher thickness than the densified zones. A transition zone region may sometimes be referred to as a “wall region.”

“Bulk Density”, as used herein, means the apparent density of an entire fibrous structure product rather than a discrete area thereof.

### Embossed Features

The present invention is equally applicable to all types of consumer paper products such as paper towels, toilet tissue, facial tissue, napkins, and the like. In one embodiment of the present invention, the fibrous structure product further comprises a plurality of embossments. Those of skill in the art may appreciate that providing an embossment pattern provides, among other benefits, improved aesthetics regarding thickness and quilted appearance. Exemplary means and apparatus for embossing are described in U.S. Pat. Nos. 3,323,983, 5,468,323, 5,693,406, 5,972,466, 6,030,690 and 6,086,715.

Those of skill in the art may appreciate that embossing is performed in the dry end of the papermaking process and/or in a completely separate process, after the cellulosic fibrous structure web has already been formed. However, it is known to those of skill in the art that thickness generated by embossing is relatively easily collapsible due to web winding tension, tight packaging and exposure to water or other liquid. Without wishing to be limited by theory, it is thought that uniform thickness of formed features (i.e., pillow regions and knuckle regions) that are provided on through-air-dried-produced fibrous structure products or patterned-belt-produced fibrous structure products deliver a relatively long-lasting thickness and bulk in use. Prior art methods of providing formed features on a fibrous structure product have focused on distributing fibers to the pillow regions of a fibrous structure product in order to provide a deeper molding of the formed features. Further, it was surprisingly discovered that a combination of fiber distribution, slurry composition, vacuum settings, and wet transfer settings provide a relatively optimized microstructure to provide the consumer benefits described supra.

### Formed Fibrous Structure Products

In one embodiment, the fibrous structure products of the present invention may be manufactured using a patterned belt. Exemplary patterned belts are described in U.S. Pat. Nos. 4,637,859, 4,514,345, 5,328,565 and 5,334,289. The belts that result from the belt making techniques disclosed in the referenced patents provide advantages over conventional belts in the art and are herein referred to as “resin coated woven belts.”

In another embodiment, the fibrous structure products of the present invention may be manufactured using through air dried (TAD) technology. It is known in the art to provide heavy calendared uncreped tissue sheets using TAD technology. Exemplary TAD processes, apparatus, and products are described in U.S. Pat. Nos. 6,273,996, 5,779,860, 6,918,993 and 4,191,609. Resultant through air dried webs are pattern densified such that zones of relatively high density are dispersed within a high bulk field, including pattern densified tissue wherein zones of relatively high density are continuous and the high bulk field is discrete. The techniques to produce fibrous structure products in this manner are taught in the prior art. For example, Eur. Pat. App. Nos. 0 677 612A2 and 0 617 164 A1, and U.S. Pat. No. 5,656,132.

In one embodiment, the patterned framework of the fabric or belt has so-called deflection conduits dispersed within the pattern. The deflection conduits extend between opposed first and second surfaces of the framework. The deflection conduits allow the fibrous structure product to extend into, and subsequently form, features in the finished paper product (i.e., provide “formed features”).

In one embodiment, the fibrous structure product substrate is a through air dried paper made according to the foregoing patents and has a plurality of formed features formed during the papermaking process (i.e., the features are “wet-formed”) which are dispersed throughout an essentially continuous network region. Without wishing to be limited by theory, it is thought that the wet-formed features that provide the essentially continuous network of wet-formed features may protrude outwardly from the plane of the paper due to molding into the deflection conduits during the papermaking process. By molding into the deflection conduits during the papermaking process, the wet-formed features may generally extend in a relatively perpendicular direction to the MD-CD plane of the paper to increase the paper's caliper. In one embodiment, the so-called wet formed features are those features which correspond to the textured surface of the belt or fabric on which the slurry which forms fibrous structure product is dried. There are an infinite variety of possible geometries, shapes, and arrangements for the deflection conduits and the domes formed in the paper therefrom. Exemplary shapes include those disclosed in U.S. Pat. No. 5,275,700.

Exemplary means and apparatus for making the fibrous structure product according to the present invention having wet-formed features are described in U.S. Pat. Nos. 4,528,239, 4,529,480, 5,275,700, 5,364,504, 5,527,428, 5,609,725, 5,679,222, 5,709,775, 5,795,440, 5,900,122, 5,906,710, 5,935,381 and 5,938,893.

### Method of Making: Fibrous Structure Slurry/Pulp Preparation

In one embodiment, the fibrous structure product may be made using an aqueous slurry of eucalyptus fibers prepared using a conventional repulper. In one embodiment, the aqueous slurry comprises NSK fibers. In another embodiment, the slurry comprises from about 30 to about 100 percent by weight of NSK fibers to provide an NSK thick stock. In another embodiment, the slurry comprises from about 40 to about 80 percent by weight of NSK fibers. In another embodiment, the slurry comprises from about 50 to about 70 percent by weight of NSK fibers.

By processing the slurry, in the exemplary embodiment, the NSK thick stock, through a conventional disk refiner, it is possible to provide the slurry with a pulp filtration resistance of from about 20° SR to about 28° SR (Standard test method EN ISO 5267-1). In some embodiments, the slurry has a pulp filtration resistance of from about 23° SR to about 25° SR. Without wishing to be limited by theory, it is thought that by using a relatively low level of pulp filtration resistance, the fibers may be adequately hydrated without excessive fibrillation or cutting.

Surprisingly, it was discovered that, inter alia, by providing by limiting fibrillation, and operating the belt and wire at a specific draw rate, the resultant fibrous structure product has a microstructure that provides a high bulk, high softness and a high hand protection factor, rather than by simply raising the basis weight alone to increase transition zone thickness.

### Method of Making: Exemplary TAD Papermaking Process

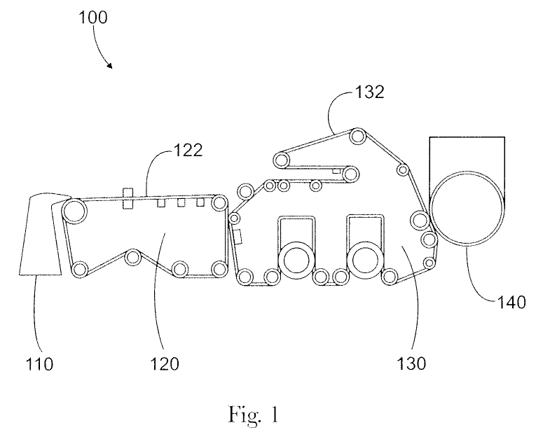

As described supra, one fibrous structure useful in achieving the fibrous structure paper product of the present invention is the through-air-dried (TAD), differential density structure described in U.S. Pat. No. 4,528,239. Such a structure may be formed according to the nonlimiting embodiment of the apparatus exemplified in FIG. 1. The apparatus 100 comprises a head box 110, a Fourdrinier section 120 comprising a Fourdrinier wire 122, a press section 130 comprising a TAD carrier fabric 132 and a Yankee Dryer 140.

In one embodiment, it is possible to operate the papermaking machine such that there is a differential velocity between the TAD carrier fabric 132 and the Fourdrinier wire 122 to provide increased fibers in the pillow regions. In many prior art applications, the Fourdrinier wire 122 is running at a higher speed than the TAD carrier fabric 132.

As described supra, it is found that some consumers prefer a relatively bulky product as compared to a relatively cushiony product. It is surprisingly found that in addition to the process/additive changes described supra, in some embodiments during the transfer of the slurry from the Fourdrinier wire to the TAD carrier fabric, if the speed of the Fourdrinier wire and the speed of the TAD carrier fabric are approximately equal, or if the Fourdrinier wire is operating at a relatively slower speed than the TAD carrier fabric, then a relatively high amount of fibers are distributed in the walls of the formed features compared to the formed features of the prior art and a relatively bulky product may be achieved. In other embodiments, the speed of the Fourdrinier wire is from about 0% to about −6% of the TAD carrier fabric (wire-to-press draw of from about 0% to about −6%). One of skill in the art will appreciate that a resin coated belt may be used instead of a TAD carrier fabric.

Without wishing to be limited by theory, it is thought that in the papermaking process, the deflection, δ, of the formed features may be altered. Deflection, which is thought to govern the formation of formed features, may be approximated is governed by the relationship of Eq. 1:

δ∝(DFL³)/(Ebh³) Eq. 1

### Where:

L accounts for, inter alia, the length of deflection (i.e., spacing between features)
F accounts for, inter alia, the normal force exerted on the web in the MD-CD plane. Without wishing to be limited by theory, it is thought that this force is driven by vacuum and/or other air transfer elements (pick up shoe vacuum, belt air permeability, couch consistency, wire-to-press draw, etc.)
E accounts for, inter alia, fiber mobility (factors such as fiber length, friction, etc.)
h accounts for, inter alia, the thickness of the sheet at transfer and other factors such as basis weight, fiber thickness, fiber layers, fiber coarseness, fiber orientation, etc.
D accounts, inter alia, for the depth of the molding fabric (i.e., TAD carrier fabric or resin coated belt)
b accounts for, inter alia, the width of the belt features.

It is surprisingly observed that by providing a fibrous structure product with a relatively high δ, the resultant product had an increased distribution of fibers towards the bottom of the mold which provides a relatively thin transition zone in the formed features. Such a product tends to be relatively cushiony, and while still desirable to many, does not appeal to certain segments of consumers. By comparison, a fibrous structure product with a relatively low 6 has a relatively consistent distribution of fibers throughout the entire formed features as opposed to having an increased density in the walls, or transition zone, of the formed features. The resultant fibrous structure product tends to be relatively bulky, appealing to a particular segment of consumers.

Optional nonlimiting process considerations are: An overburden of from about 8 to about 22 mils. It is thought that having such a range allows for a relatively good space for the product to form into. Couch consistency of from about 16% to about 25%. It is thought that such a range allows for optimal normal force. Pick up shoe vacuum of from about 4.5 mmHg to about 12 mmHg. It is thought that such a range allows for optimal normal force. Fiber coarseness of above 0.2 mg/g. It is thought that such a range allows for optimal sheet thickness.

### Resultant Formed Features

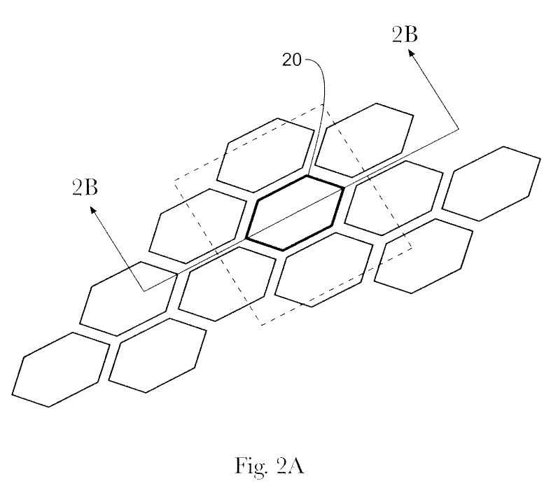

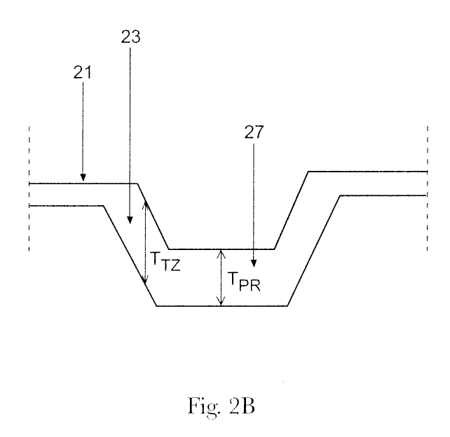

FIG. 2A shows a perspective view of a portion of an exemplary fibrous structure product 10 according to the present invention. The fibrous structure product is made as described supra and comprises a plurality of formed surface features 20.

FIG. 2B shows a cross sectional view of the exemplary fibrous structure product 10 shown in FIG. 2A taken along line 2B-2B. The formed surface features 20 comprise a knuckle region 21, a transition zone 23, and a pillow region 27. The transition zone 23 comprises a transition zone thickness T_{TZ} and the pillow region comprises a pillow region thickness T_{PR}. In one embodiment, the transition zone T_{TZ} is thickness is from about 60 to about 120 μm. In another embodiment, the transition zone thickness T_{TZ} is from about 80 to about 100 μm. In some embodiments, the ratio of T_{TZ} to T_{PR} is greater than about 0.8. In other embodiments, the ratio of T_{TZ} to T_{PR} is from about 0.8 to about 1.2. In other embodiments, the ratio of T_{TZ} to T_{PR} is from about 0.8 to about 1.0. T_{TZ} and T_{PR} may be measured according to the Average Thickness Test Method/MicroCT Method described infra. In one embodiment the formed surface features 20 comprise discontinuous knuckles. In another embodiment the formed features comprise semicontinuous knuckles.

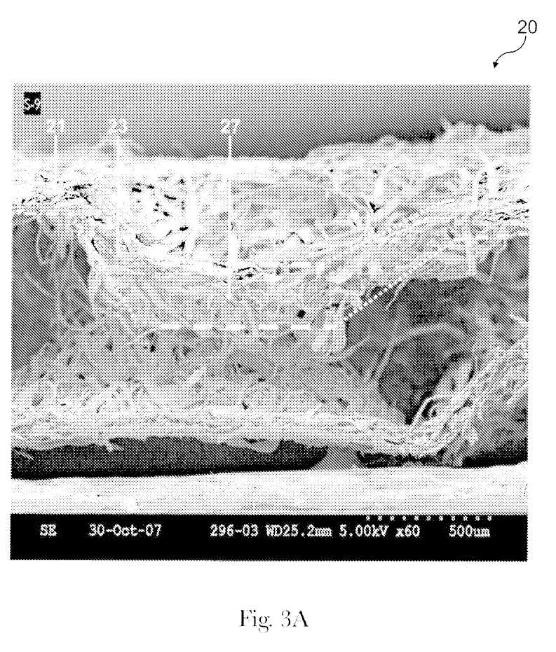

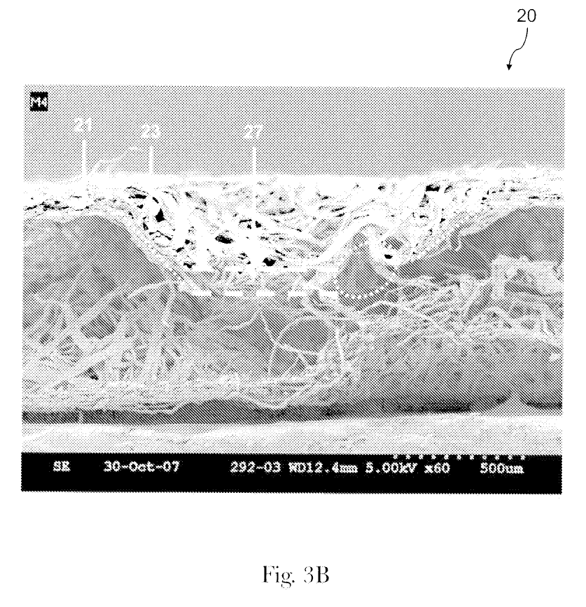

FIG. 3A shows a scanning-electron microscope (SEM) image of an exemplary fibrous structure product comprising a formed surface feature 20 made according to the present invention. The basis weight and fiber composition of the exemplary product is the same as the prior art product of FIG. 3B. The formed surface feature 20 comprises a knuckle region 21, a transition zone 23, and a pillow region 27. One of skill in the art may observe that the transition zone 23 of the present invention is relatively thicker and that the distribution of fibers appears to be more uniform throughout the entire feature 20 than throughout a transition zone 23 of the prior art.

FIG. 3B shows a scanning-electron microscope (SEM) image of an exemplary fibrous structure product comprising a formed surface feature 20 made according to prior art. The formed surface feature 20 comprises a knuckle region 21, a transition zone 23, and a pillow region 27.

### Resultant Formed Features: Liquid Uptake

Surprisingly, it is the case that consumers not only prefer a cushy and highly absorbent product, but that consumers also prefer a product that provides for “dry hands” during use. In other words, consumers prefer a product wherein liquid that is being absorbed (i.e., a water spill) is kept to a relatively low level of contact to the user's hands, at the same time without sacrificing absorbency of the product. As described supra, the microstructure of the present invention fibrous structure product is such that there is a homogeneous fiber distribution and relatively significant reduction of apertures throughout the walls of the product. Without wishing to be limited by theory, it is thought that by providing a homogeneous fiber distribution throughout the walls of the product, not only do the walls of the formed features become thicker, there is also a more tortuous path for liquids to travel in the Z-direction.

The ability of an absorbent fibrous structure product to minimize the amount of liquid that is allowed contact with the user's hands. This may be described as a “hand protection factor” (HPF). The method for determining the HPF is described infra in the Hand Protection Factor Method section. One of skill in the art may appreciate that HPF may be manipulated by chemical additives and increasing basis weight, both of which may lead to increased production costs. The present invention improves HPF by providing a novel microstructure to the formed features of the fibrous structure product. HPF results of exemplary embodiments of the present invention fibrous structure product and prior art samples having formed surface features are described below in Table 1.

One of skill in the art will appreciate that one way to increase the efficacy of a fibrous structure product that is used with liquid is to increase the amount of fibers—in other words, increase the basis weight—of the product. However, one of skill in the art may also appreciate that such a strategy may not be the very cost-effective due to the additional costs associated with the inclusion of extra materials. It is surprisingly found that some embodiments of the present invention fibrous structure product provide a hand protection factor that is comparable to that of products with much higher basis weight.

TABLE 1
Hand Protection Factor Results

| | Formed Feature | | Basis Weight | |
|---|---|---|---|---|
| Plies | Format | Sample | (lbs/3000 ft²) | HPF (×10⁻²) |
| 2 ply | Continuous | | | |
| | knuckles | Bounty ® | 25 | 1.60-1.65 |
| | | (Previous | | |
| | | Mainline) | | |
| | | Bounty ® | 27 | 1.69-1.75 |
| | | (Current | | |
| | | Mainline) | | |
| | | Present | 28 | 2.00-2.60 |
| | | Invention | | |
| | | Bounty ® Extra | 36 | 3.47-3.81 |
| | | Soft | | |
| 1 ply | Discontinuous | Present | 23 | 3.3 |
| | Knuckles | Invention | | |

In one embodiment, the present invention fibrous structure product comprises an HPF for a two-ply product of greater than about 2×10⁻². In another embodiment, the fibrous structure product comprises an HPF for a two-ply product of from about 2×10⁻² to about 1×10⁻¹. In one embodiment, the basis weight of a two-ply product of the present invention fibrous structure product is from about 20 lbs/3000 ft² to about 32 lbs/3000 ft². In another embodiment, the basis weight of a two-ply product is from about 25 lbs/3000 ft² to about 32 lbs/3000 ft². In another embodiment still, the basis weight of a two-ply product is less than 32 lbs/3000 ft².

In one embodiment, the present invention fibrous structure product comprises an HPF for a one-ply product of greater than about 2×10⁻². In another embodiment still, the present invention fibrous structure product comprises an HPF for a one-ply product of greater than about 3×10⁻². In yet another embodiment, the present invention fibrous structure product comprises an HPF for a one-ply product of from about 2×10⁻² to about 4×10⁻². In a different embodiment, the present invention fibrous structure product comprises an HPF for a one-ply product of from about 3×10⁻² to about 4×10⁻². In one embodiment, the basis weight of a one-ply product of the present invention fibrous structure product is from about 13 lbs/3000 ft² to about 30 lbs/3000 ft². In another embodiment, the basis weight of a one-ply product of the present invention fibrous structure product is from about 16 lbs/3000 ft² to about 30 lbs/3000 ft².

In another embodiment, the basis weight of a two-ply product is from about 20 lbs/3000 ft² to about 26 lbs/3000 ft². In one embodiment, a one-ply product of the present invention fibrous structure product has a basis weight of greater than about 13 lbs/3000 ft². In another embodiment, a one-ply product of the present invention fibrous structure product has a basis weight of greater than about 16 lbs/3000 ft². In yet another embodiment, a one-ply product of the present invention fibrous structure product has a basis weight of greater than about 20 lbs/3000 ft².

In nonlimiting embodiments, the surface features of a one-ply, or a two-ply product, may be continuous, semicontinuous and/or discontinuous. Without wishing to be limited by theory, it is thought that the advantage observed in the one-ply products (i.e., having an HPF as high as a two-ply product with a similar basis weight) is achieved by providing formed features having knuckles that are in a semicontinuous or a discontinuous configuration because the molding dynamics are governed by those in Eq. 1 and can be controlled (as described throughout) to provide uniform fiber distribution throughout the features. By comparison, many prior art products use continuous knuckles. It is surprisingly discovered that such features are governed by different molding dynamics and provide benefits different than those which are described herein.

### Sheet Compression

In addition to the in-hand bulkiness that the present invention provides, certain embodiments of the fibrous structure product of the present invention also provides a high level of resiliency when compressed. One of skill in the art will appreciate the use of a “high load caliper” test to calculate the ability of a paper towel or other absorbent paper product to resist a load. However, many consumers appreciate the ability of a paper towel to absorb and then “spring back” from an applied load.

The ability of a fibrous structure product to spring back from an applied load is hereinafter referred to as the “Resistance Factor” or Fᵣₑₛ. The resistance factor may be calculated from the measurement of the caliper of a two-ply sample at loads of 10 g (C_{10, ini}—the sample under an initial load of 10 g), 1500 g (C₁₅₀₀—the sample under a load of 1500 g), and 10 g (C_{10, after}—the sample under a load of 10 g, after being subjected to a load of 1500 g). The Resistance Factor (F_{res.}) may be calculated as in Eq. 2:

F_{res.}=ln[(C_{10, ini.}−C₁₅₀₀)/C_{10, after}] Eq. 2

The caliper measurements under load may be measured using the “High Load Caliper Method” described infra. Resistance Factor results of exemplary embodiments of the present invention fibrous structure product and prior art samples (2-ply) are described in Table 2.

In one embodiment the Resistance Factor of a fibrous structure product of greater than about −0.20. In another embodiment, the Resistance Factor of a two-ply fibrous structure product is greater than about −0.1. In another embodiment still, the Resistance Factor of a fibrous structure product is from about −0.20 to 0. In another embodiment, the Resistance Factor of a two-ply fibrous structure product is from about −0.1 to 0.

TABLE 2
Resistance Factor Results

| | | | | | Bounty ® | |
|---|---|---|---|---|---|---|
| | | | | Bounty ® | Previous | Present |
| | Viva ® | Sparkle ® | Scott ® | Extra Soft | Mainline | Invention |
| C_{10 ini} | 34.3 | 33.9 | 34.0 | 39.6 | 35.53 | 43.5 |
| C_{10 after} | 27.9 | 26.8 | 28.3 | 33.1 | 28.18 | 29.8 |
| C₁₅₀₀ | 17.5 | 13.4 | 12.2 | 17.2 | 14.28 | 15.3 |
| C_{10 ini} − C₁₅₀₀ | 16.7 | 20.5 | 21.8 | 22.4 | 21.3 | 28.2 |
| Resistance Factor | −0.5 | −0.3 | −0.3 | −0.4 | −0.3 | −0.1 |

An alternative measurement of sheet resiliency is the Load Compression Rate (LCR), which measures the difference in caliper at a load of 1500 g and the caliper at a load of 300 g. Without wishing to be limited by theory, it is thought that Load Compression Rate (LCR) is a relatively good indicator of how bulky a consumer will find a product will be. The Load Compression Rate (LCR) may be described by Eq. 3:

LCR=C₃₀₀−C₁₅₀₀ Eq. 3

The caliper measurements under load may be measured using the “High Load Caliper Method” described infra. Load Compression Rate results of exemplary embodiments of the present invention fibrous structure product and prior art samples (1-ply) are described in Table 3.

TABLE 3
Load Compression Rate

| | | | | 300-1500 g |
|---|---|---|---|---|
| | | | Basis Weight | Compression |
| Plies | Structure | Sample Name | (lbs/3000 ft²) | Rate |
| 1 ply | Continuous | Bounty ® | 12.5 | 12.3 |
| | knuckles | (Previous Mainline) | | |
| | | Bounty ® | 13.5 | 9.8 |
| | | Present Invention | 14 | 7.9 |
| | | Bounty ® Extra Soft | 18 | 9.3 |
| | | Bounty ® Basic | 23 | 10.4 |

In one embodiment, the present invention fibrous structure product comprises an LCR for a one-ply product of less than about 9. In another embodiment still, the present invention fibrous structure product comprises an HPF for a one-ply product of less than about 8. In yet another embodiment, the present invention fibrous structure product comprises an HPF for a one-ply product of from about 5 to about 9. In a different embodiment, the present invention fibrous structure product comprises an HPF for a one-ply product of from about 5 to about 8. In one embodiment, the basis weight of a one-ply product of the present invention fibrous structure product is from about 10 lbs/3000 ft² to about 20 lbs/3000 ft². In another embodiment, the basis weight of a two-ply product is from about 12 lbs/3000 ft² to about 20 lbs/3000 ft². In another embodiment still, the LCR described infra are for products with surface features having continuous knuckles.

### Optional Ingredients

The fibrous structure product may be in roll form. When in roll form, the product may be wound about a core or may be wound without a core.

The fibrous structure product herein may optionally comprise one or more ingredients that may be added to the aqueous papermaking furnish or the embryonic web. These optional ingredients may be added to impart other desirable characteristics to the product or improve the papermaking process so long as they are compatible with the other components of the fibrous structure product and do not significantly and adversely affect the functional qualities of the present invention. The listing of optional chemical ingredients is intended to be merely exemplary in nature, and is not meant to limit the scope of the invention. Other materials may be included as well so long as they do not interfere or counteract the advantages of the present invention.

A cationic charge biasing species may be added to the papermaking process to control the zeta potential of the aqueous papermaking furnish as it is delivered to the papermaking process. These materials are used because most of the solids in nature have negative surface charges, including the surfaces of cellulosic fibers and fines and most inorganic fillers. In one embodiment the cationic charge biasing species is alum. In addition charge biasing may be accomplished by use of relatively low molecular weight cationic synthetic polymer, in one embodiment having a molecular weight of no more than about 500,000 and in another embodiment no more than about 200,000, or even about 100,000. The charge densities of such low molecular weight cationic synthetic polymers are relatively high. These charge densities range from about 4 to about 8 equivalents of cationic nitrogen per kilogram of polymer. An exemplary material is Cypro 514®, a product of Cytec, Inc. of Stamford, Conn.

High surface area, high anionic charge microparticles for the purposes of improving formation, drainage, strength, and retention may also be included herein. See, for example, U.S. Pat. No. 5,221,435.

If permanent wet strength is desired, cationic wet strength resins may be optionally added to the papermaking furnish or to the embryonic web. From about 2 to about 50 lbs./ton of dry paper fibers of the cationic wet strength resin may be used, in another embodiment from about 5 to about 30 lbs./ton, and in another embodiment from about 10 to about 25 lbs./ton.

The cationic wet strength resins useful in this invention include without limitation cationic water soluble resins. These resins impart wet strength to paper sheets and are well known to the paper making art. These resins may impart either temporary or permanent wet strength to the sheet. Such resins include the following Hercules products. KYMENE® resins obtainable from Hercules Inc., Wilmington, Del. may be used. An exemplary variant of KYMENE® is KYMENE® 736 which is a polyethyleneimine (PEI) wet strength polymer.

In one embodiment, the cationic wet strength resin may be added at any point in the processes, where it will come in contact with the paper fibers prior to forming the wet web. For example, the cationic wet strength resin may be added to the thick or the thin stock directly, in may be added at the tray, the fan pump, the head box, the machine chest, the dump chest or the pulper. In another embodiment the cationic wet strength resin is added to the thick stock. It should be noted, however, that the optimal addition point may very from paper machine to paper machine and from grade of paper to grade of paper.

Many paper products must have limited strength when wet because of the need to dispose of them through toilets into septic or sewer systems. If wet strength is imparted to these products, fugitive wet strength, characterized by a decay of part or all of the initial strength upon standing in presence of water, is preferred. If fugitive wet strength is desired, the binder materials can be chosen from the group consisting of dialdehyde starch or other resins with aldehyde functionality such as Co-Bond 1000® offered by National Starch and Chemical Company of Scarborough, Me.; Parez 750® offered by Cytec of Stamford, Conn.; and the resin described in U.S. Pat. No. 4,981,557, and other such resins having the decay properties described above as may be known to the art.

If enhanced absorbency is needed, surfactants may be used to treat the paper webs of the present invention. The level of surfactant, if used, in one embodiment, from about 0.01% to about 2.0% by weight, based on the dry fiber weight of the tissue web. In one embodiment the surfactants have alkyl chains with eight or more carbon atoms. Exemplary anionic surfactants include linear alkyl sulfonates and alkylbenzene sulfonates. Exemplary nonionic surfactants include alkylglycosides including alkylglycoside esters such as Crodesta SL40® which is available from Croda, Inc. (New York, N.Y.); alkylglycoside ethers as described in U.S. Pat. No. 4,011,389; and alkylpolyethoxylated esters such as Pegosperse 200 ML available from Glyco Chemicals, Inc. (Greenwich, Conn.) and IGEPAL RC-520® available from Rhone Poulenc Corporation (Cranbury, N.J.). Alternatively, cationic softener active ingredients with a high degree of unsaturated (mono and/or poly) and/or branched chain alkyl groups can greatly enhance absorbency.

### Optional: Debonding/Chemical Softening Agents

Without wishing to be limited by theory, it is also thought that the addition of a debonding agent may facilitate the debonding of fibers to provide for a higher accumulation of fibers in the transition zone regions.

In one embodiment the debonding agents comprise quaternary ammonium compounds including, but not limited to, the well-known dialkyldimethylammonium salts (e.g., ditallowedimethylammonium chloride, ditallowedimethylammonium methyl sulfate (“DTDMAMS”), di(hydrogenated tallow)dimethyl ammonium chloride, etc.). In another embodiment variants of these softening agents include mono or diester variations of the before mentioned dialkyldimethylammonium salts and ester quaternaries made from the reaction of fatty acid and either methyl diethanol amine and/or triethanol amine, followed by quaternization with methyl chloride or dimethyl sulfate.

Another class of papermaking-added debonding agents comprises organo-reactive polydimethyl siloxane ingredients, including the amino functional polydimethyl siloxane. The fibrous structure product of the present invention may further comprise a diorganopolysiloxane-based polymer. These diorganopolysiloxane-based polymers useful in the present invention span a large range of viscosities; from about 10 to about 10,000,000 centistokes (cSt) at 25° C. Some diorganopolysiloxane-based polymers useful in this invention exhibit viscosities greater than 10,000,000 centistokes (cSt) at 25° C. and therefore are characterized by manufacturer specific penetration testing. Examples of this characterization are GE silicone materials SE 30 and SE 63 with penetration specifications of 500-1500 and 250-600 (tenths of a millimeter) respectively.

Among the diorganopolysiloxane polymers of the present invention are diorganopolysiloxane polymers comprising repeating units, where said units correspond to the formula (R₂SiO)ₙ, where R is a monovalent radical containing from 1 to 6 carbon atoms, in one embodiment selected from the group consisting of methyl, ethyl, propyl, isopropyl, butyl, isobutyl, t-butyl, amyl, hexyl, vinyl, allyl, cyclohexyl, amino alkyl, phenyl, fluoroalkyl and mixtures thereof. The diorganopoylsiloxane polymers which may be employed in the present invention may contain one or more of these radicals as substituents on the siloxane polymer backbone. The diorganopolysiloxane polymers may be terminated by triorganosilyl groups of the formula (R′₃Si) where R′ is a monovalent radical selected from the group consisting of radicals containing from 1-6 carbon atoms, hydroxyl groups, alkoxyl groups, and mixtures thereof. In one embodiment the silicone polymer is a higher viscosity polymers, e.g., poly(dimethylsiloxane), herein referred to as PDMS or silicone gum, having a viscosity of at least 100,000 cSt.

Silicone gums, optionally useful herein, corresponds to the formula:

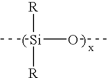

where R is a methyl group.

Fluid diorganopolysiloxane polymers that are commercially available, include SE 30 silicone gum and SF96 silicone fluid available from the General Electric Company. Similar materials can also be obtained from Dow Corning and from Wacker Silicones.

An additional fluid diorganosiloxane-based polymer optionally for use in the present invention is a dimethicone copolyol. The dimethicone copolyol can be further characterized as polyalkylene oxide modified polydimethysiloxanes, such as manufactured by the Witco Corporation under the trade name Silwet. Similar materials can be obtained from Dow Corning, Wacker Silicones and Goldschmidt Chemical Corporation as well as other silicone manufacturers. Silicones useful herein are further disclosed in U.S. Pat. Nos. 5,059,282; 5,164,046; 5,246,545; 5,246,546; 5,552,345; 6,238,682; 5,716,692.

The debonding agents are generally useful at a level of from about 0.05 lbs/ton to about 300 lbs/ton, in another embodiment from about 0.2 lbs/ton to about 60 lbs/ton, and in another embodiment from about 0.4 lbs/ton to about 6 lbs/ton.

Filler materials may also be incorporated into the fibrous substrate products of the present invention. U.S. Pat. No. 5,611,890 discloses filled tissue-towel paper products that are acceptable as substrates for the present invention.

In addition antibacterial agents, coloring agents such as print elements, perfumes, dyes, and mixtures thereof, may be included in the fibrous structure product of the present

### EXAMPLES

### Example 1

### Present Invention Method of Making

The Eucalyptus fiber slurry is diluted with white water at the inlet of a fan pump to a consistency of about 0.15% based on the total weight of the eucalyptus fiber slurry. The NSK fibers, likewise, are diluted with white water at the inlet of a fan pump to a consistency of about 0.15% based on the total weight of the NSK fiber slurry. The eucalyptus fiber slurry and the NSK fiber slurry are both directed to a non layered configuration the headbox such that the wet web formed onto a Fourdrinier wire is about 30% is made up of the eucalyptus fibers and about 70% is made up of the NSK fibers. “DC 2310” (Dow Corning, Midland, Mich.) antifoam is dripped into the wirepit to control foam to maintain whitewater levels of 10 ppm.

Dewatering occurs through the Fourdrinier wire and is assisted by a deflector and vacuum boxes. The Fourdrinier wire is of a 5-shed, satin weave configuration having 87 machine-direction and 76 cross-machine-direction monofilaments per inch, respectively. The speed of the Fourdrinier wire is about 750 fpm (feet per minute).

The embryonic wet web is transferred from the Fourdrinier wire at a fiber consistency of about 24% at the point of transfer, to a TAD carrier fabric. To provide fibrous structure products of the present invention, the speed of the patterned drying fabric is approximately the same as the speed of the Fourdrinier wire.

Further de-watering is accomplished by vacuum assisted drainage until the web has a fiber consistency of about 30%.

While remaining in contact with the patterned drying fabric, the web is pre-dried by air blow-through pre-dryers to a fiber consistency of about 65% by weight.

After the pre-dryers, the semi-dry web is transferred to the Yankee dryer and adhered to the surface of the Yankee dryer with a sprayed creping adhesive. The creping adhesive is an aqueous dispersion with the actives consisting of about 22% polyvinyl alcohol, about 11% CREPETROL A3025, and about 67% CREPETROL R6390. CREPETROL A3025 and CREPETROL R6390 are commercially available from Hercules Incorporated of Wilmington, Del. The creping adhesive is delivered to the Yankee surface at a rate of about 0.15% adhesive solids based on the dry weight of the web. The fiber consistency is increased to about 97% before the web is dry creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350 Fahrenheit (about 177 Celsius) and a speed of about 800 fpm. The fibrous structure is wound in a roll using a surface driven reel drum having a surface speed of about 656 feet per minute. The fibrous structure may be subsequently converted into a two-ply kitchen towel product having a basis weight of about 28 lbs/3000 ft².

The resultant fibrous structure product has a wall thickness of about 80 μm and a ratio of T_{TZ} to T_{PR} of about 0.9.

### Example 2

### Prior Art Method of Making

One fibrous structure useful in achieving the fibrous structure paper product of the present invention is the through-air-dried (TAD), differential density structure described in U.S. Pat. No. 4,528,239. Such a structure may be formed by the following process.

A Fourdrinier, through-air-dried papermaking machine is used. A slurry of papermaking fibers is pumped to the headbox at a consistency of about 0.15%. The slurry consists of about 70% Northern Softwood Kraft fibers and about 30% unrefined Eucalyptus fibers. The slurry further comprises a cationic polyamine-epichlorohydrin wet burst strength resin at a concentration of about 21 lbs per ton of dry fiber, and carboxymethyl cellulose at a concentration of about 4.7 lbs per ton of dry fiber.

Dewatering occurs through the Fourdrinier wire and is assisted by vacuum boxes. The embryonic wet web is transferred from the Fourdrinier wire at a fiber consistency of about 24% at the point of transfer, to a TAD carrier fabric. The wire speed is about 721 feet per minute. The carrier fabric speed is about 700 feet per minute. Since the wire speed is faster than the carrier fabric, wet shortening of the web occurs at the transfer point. Thus, the wet web foreshortening is about 3%. The sheet side of the carrier fabric consists of a continuous, patterned network of photopolymer resin, the pattern containing about 200 deflection conduits or domes per square inch. The deflection conduits or domes are arranged in a regular configuration, and the polymer network covers about 24% of the surface area of the carrier fabric. The polymer resin is supported by and attached to a woven support member. The photopolymer network rises about 14 mils above the support member.

The consistency of the web is about 60% after the action of the TAD dryers operating about a 410 F, before transfer onto the Yankee dryer. An aqueous solution of creping adhesive is applied to the Yankee surface by spray applicators before location of sheet transfer. The fiber consistency is increased to an estimated 97% before creping the web with a doctor blade. The doctor blade has a bevel angle of about 25 degrees and is positioned with respect to the Yankee dryer to provide an impact angle of about 81 degrees. The Yankee hoods are operated at about 500 F.

The dry, creped web is passed between two calendar rolls and rolled on a reel operated at 560 feet per minute so that there is about 7% foreshortening of the web by crepe.

The paper described above is then subjected to a knob-to-rubber impression embossing process as follows. An emboss roll is engraved with a nonrandom pattern of protrusions. The emboss roll is mounted, along with a backside impression roll, in an apparatus with their respective axes being generally parallel to one another. The emboss roll comprises embossing protrusions which are frustaconical in shape. The backside impression roll is made of Valcoat™ material from Valley Roller Company, Mansfield, Tex. The paper web is passed through the nip to create an embossed ply.

The resultant fibrous structure product has a wall thickness of about 40 μm and a ratio of T_{TZ} to T_{PR} of about 0.6.

### Test Methods

The following describe the test methods utilized herein to determine the values consistent with those presented herein.

All measurements for the test methods are made at 23+/−1° C. and 50% relative humidity, unless otherwise specified.

### Basis Weight Method

Basis weight is measured by preparing one or more samples of a certain area (3000 ft² or m²) and weighing the sample(s) of a fibrous structure according to the present invention and/or a fibrous structure product comprising such fibrous structure on a top loading balance with a minimum resolution of 0.01 g. The balance is protected from air drafts and other disturbances using a draft shield. Weights are recorded when the readings on the balance become constant. The average weight (lbs or g) is calculated and the average area of the samples (3000 ft² or m²). The basis weight (lbs/3000 ft² or g/m²) is calculated by dividing the average weight (lbs or g) by the average area of the samples (3000 ft² or m²). This method is herein referred to as the Basis Weight Method.

### Caliper Method

Samples are conditioned at 23+/−1° C. and 50% relative humidity for two hours prior to testing.

Sheet Caliper or Loaded Caliper of a sample of fibrous structure product is determined by cutting a sample of the fibrous structure product such that it is larger in size than a load foot loading surface where the load foot loading surface has a circular surface area of about 3.14 in². The sample is confined between a horizontal flat surface and the load foot loading surface. The load foot loading surface applies a confining pressure to the sample of about 14.7 g/cm² (about 0.21 psi). The caliper is the resulting gap between the flat surface and the load foot loading surface. Such measurements can be obtained on a VIR Electronic Thickness Tester Model II available from Thwing-Albert Instrument Company, Philadelphia, Pa. The caliper measurement is repeated and recorded at least five (5) times so that an average caliper can be calculated. The result is reported in mils.

### High Load Caliper Method

Caliper versus load data are obtained using a Thwing-Albert Model EJA Materials Tester, equipped with a 2000 g load cell and compression fixture. The compression fixture consisted of the following; load cell adaptor plate, 2000 gram overload protected load cell, load cell adaptor/foot mount 1.128 inch diameter presser foot, #89-14 anvil, 89-157 leveling plate, anvil mount, and a grip pin, all available from Thwing-Albert Instrument Company, Philadelphia, Pa. The compression foot is one square inch in area. The instrument is run under the control of Thwing-Albert Motion Analysis Presentation Software (MAP V1,1,6,9). A single sheet of a conditioned sample is cut to a diameter of approximately two inches. Samples are conditioned for a minimum of 2 hours at 23+/−1° C. and 50±2% relative humidity. Testing is carried out under the same temperature and humidity conditions. The sample must be less than 2.5-inch diameter (the diameter of the anvil) to prevent interference of the fixture with the sample. Care should be taken to avoid damage to the center portion of the sample, which will be under test. Scissors or other cutting tools may be used. For the test, the sample is centered on the compression table under the compression foot. The compression and relaxation data are obtained using a crosshead speed of 0.1 inches/minute. The deflection of the load cell is obtained by running the test without a sample being present. This is generally known as the Steel-to-Steel data. The Steel-to-Steel data are obtained at a crosshead speed of 0.005 in/min. Crosshead position and load cell data are recorded between the load cell range of 5 grams and 1500 grams for both the compression and relaxation portions of the test. Since the foot area is one square inch this corresponded to a range of 5 grams/sq in to 1500 grams/sq in. The maximum pressure exerted on the sample is 1500 g/sq in. At 1500 g/sq in the crosshead reverses its travel direction. Crosshead position values are collected at 30 selected load values during the test. These correspond to pressure values of 10, 25, 50, 75, 100, 125, 150, 200, 300, 400, 500, 600, 750, 1000, 1250, 1500, 1250, 1000, 750, 500, 400, 300, 250, 200, 150, 125, 100, 75, 50, 25, 10 g/sq. in. for the compression and the relaxation direction. During the compression portion of the test, crosshead position values are collected by the MAP software, by defining fifteen traps (Trap 1 to Trap 15) at load settings of 10, 25, 50, 75, 100, 125, 150, 200, 300, 400, 500, 600, 750, 1000, 1250. During the return portion of the test, crosshead position values are collected by the MAP software, by defining fifteen return traps (Return Trap 1 to Return Trap 15) at load settings of 1250, 1000, 750, 500, 400, 300, 250, 150, 125, 100, 75, 50, 25, 10. The thirtieth trap is the trap at max load (1500 g). Again values are obtained for both the Steel-to-Steel and the sample. Steel-to-Steel values are obtained for each batch of testing. If multiple days are involved in the testing, the values are checked daily. The Steel-to-Steel values and the sample values are an average of four replicates (1500 g).

Caliper values are obtained by subtracting the average Steel-to-Steel crosshead trap values from the sample crosshead trap value at each trap point. For example, the values from two, three, or four individual replicates on each sample are averaged and used to obtain plots of the Caliper versus Load and Caliper versus Log(10) Load. High Load Caliper is the average caliper at 1,500 g/sq. inch.

### Hand Protection Factor Method

The Hand Protection Factor (HPF) is measured by taking a sample of a fibrous structure product and measuring the basis weight (#/3000 ft²). Next, a SIZE sample of the same fibrous structure product is taken, and the number of formed features in that area is recorded. The quotient (number of features/area) may be used to calculate the basis weight for a micro structure (i.e., formed) feature in #/ft². The transition wall thickness and pillow wall thickness (microns) are measured by the Wall Thickness Method described infra.

The known values may be related as follows:

$$Theoretical C F P unrefined fiber {volume}_{{ft}^{3}} = ( \frac{C F P Basis weight \times 3.531467 \times {10}^{- 5}}{1.24} )$$

$$Actual pillow {volume}_{{ft}^{3}} = 1 / 3 \times {( p illow wall thickness )}^{2} \times [ ( 3 r ) - p illow wall thicknes ]$$

$$r = 1 ply reel caliper$$

Then use the following relationship:

$$Z \text{-} direction Tortous Path Factor = \frac{Theoretical C F P unrefined fiber volume}{Actual pillow volume}$$

The hand protection factor may be measured as follows:

$$Hand Protection Factor = \frac{Transition Wall thickness}{Pillow wall thickness} \times Z \text{-} direction Tortous Path Factor$$

### Micro CT Wall Thickness Method

Micro CT provides a visual depiction of the relative basis weight of different regions of the cellulosic fibrous structure product in the Z-direction using X-rays. One of skill in the art will appreciate that the described methodology is exemplary and nonlimiting.

As described herein, Micro CT reports the X-ray absorption of a sample specimen in the three-dimensional Cartesian coordinates system. The obtained 3D dataset is thus analyzed via MATLAB® image processing software application to determine the relative basis weight, thickness and density of the 3D material structures extending outwardly beyond the reference level of the application substrate.

### Micro-Tomography:

The sample specimen is irradiated with X-rays. The radiation transmitted through the sample is collected into an X-ray scintillator to transform the X-rays into electromagnetic radiations readable by the CCD elements of an array camera. The obtained 2D image, also referred to as a “projected image” or “shadow image”, is not sufficient alone to determine independently the X-ray absorption specific for each volume elements (voxels) located along the transmission lines of the X-rays radiated from the source through the sample to the camera. To do so, several projected images taken from different angles are needed to reconstruct the 3D space. The sample specimen is thus rotated (either 180° or 360°) with the smallest possible rotation steps to increase precision. Additional corrections eliminate the positive blur in the back projection process and the distortions induced by the cone beam geometry associated with using a 2D detector.

### Equipment:

A high resolution desktop X-ray micro-tomography instrument (e.g. Scanco μCT 40);
A 3D dataset analysis (e.g. a high performance computer to run MATLAB®+Image Processing Toolbox).

### Test-Procedure:

### 1. Sample Preparation

A 20 mm disc is cut from the substrate sample containing the 3D material structures of interest. For 2ply paper products, the plies are carefully separated after cutting down to the correct sample size. Great care must be applied to avoid any laminate stretch or deformation. The sample specimen is positioned horizontally between two 20.5 mm diameter Styrofoam rings inside a 20.5 mm inner diameter sample tube. This positioning allows for analysis of a small area in the center of the sample, with no interference from other materials.

### 2. Scanning Parameters

For the Scanco μCT 40 scanner, the peak voltage of the X-ray source is 35 kVp, the source current is 110 μA, the pixel size is 10 μm, number of slices obtained varied based on sample thickness, typical settings were between 200-377 slices. The sample rotation cycle is 360°, the rotating step is 0.18°, the beam exposure time at each rotating step is 300 ms, the frame averaging for signal-to-noise reduction is 10. The lowest energy X-rays are filtered through 0.5 mm Aluminum. No random movement to reduce ring artifacts is applied.

### 3. Reconstruction Protocol

The 3D dataset is reconstructed from the projected images obtained at each rotating steps as 2048×2048 pixels matrix per each depth slice, each pixel containing the X-ray absorption in 16 bit depth format. The pixel size is maintained at 10 μm. Noise smoothing is set as low as possible. Additional post-processing ring artifacts reduction is not required or set to minimum. No X-ray beam hardening correction is required on low X-ray absorbing material or set to minimum.

### 4. 3D Image Analysis

### The Data File:

The CT instrument scans a sample and produces a volume image. One of skill in the art will appreciate that the volume image can be thought of as a 3 dimensional representation of the density of the sample wherein the density of the sample is related to the x-ray absorbance of the material. One of skill in the art will also appreciate that by taking numerous x-ray images all the way around the sample, the instrument can reconstruct this into a volume image of the density of the image.

Without wishing to be limited by theory, it is thought that the image can be thought of as a 3-dimensional array of numbers. Each element of this array can be thought of as being spatially representing the density of the sample at the same position in the image. For example, if a volume image is created that has 1000 elements laterally in both the x and y direction, and 100 elements vertically in the z, or depth, dimension, then element (x=200, y=300, z=40) would represent a point in the sample that is 20% over (within the field of view) in the x direction, 30% over in the y direction, and 40% deep in the z direction. Each element is called a “voxel” (derived from “volume element”). If data from a single depth is being considered, this 2 dimensional array is called a “slice.” Voxels that are within a slice are commonly called “pixels” as is the standard for 2-dimensional images in the image processing field, although they could be called voxels as well. The value of the voxel or pixel is often called “gray level.”

The image consists of a data file with a format that is designed by the CT instrument manufacturer. The file extension for this format is “.isq.” The data in the file begins with of a header that describes information about the volume image, such as number of voxels in the x, y, and z direction, the number of data bits per voxel, etc. The voxel values follow the header and are written slice-by-slice, that is, all the voxels of slice 1 are written first, followed by all the voxels of slice 2, etc.

### Image Analysis-Image Generation

The image analysis consists of going through the volume image slice by slice to create 2-dimensional images that represent several features along the z, or thickness, direction:
1. The “mass density” of the sample. This is the “basis weight” of the sheet, or the mass per unit area. By using some calibration coefficient that we input, the image has units of grams per square meter.
2. The top layer image. This is elevation or topographical data, or the height of the outermost top surface of the sheet above a flat reference such as a table top.
3. The bottom layer image. This is the top layer except for the bottom surface of the sheet.
4. The thickness of the sheet. This is simply the top layer minus the bottom layer. The result is an image which is the thickness of the sheet at any point in the 2-dimensional field of view.
5. The “volume density” of the sample. This is density described in mass per unit volume. This may be derived by dividing the basis weight image by the thickness image.

The above images are built up according to the following methodology:
1. A volume image file is selected by the user for analysis.
2. The user visually determines starting and ending slice.
3. The user specifies a threshold that determines how dense a voxel needs to be before it is considered as part of the sample. This eliminates noise in empty spaces of image that would otherwise be considered as material. One of skill in the art will appreciate that a proper threshold ensures nice contrast in the final images by eliminating a noisy “fog” that would otherwise reduce the contrast.
4. The user enters a slope value and an offset value as calibration factors. The basis weight image will use these to convert it into real world units of grams per square meter. The default value of the slope is 1 and the default value of the offset is 0. If the user leaves these values as is, then the values for basis weight would be the same as the voxel values.
5. A slice is read from the volume image data file. The number of this slice is recorded for future reference.
6. The slice is thresholded so that values below the threshold are set to zero and those equal to or above the threshold are maintained at their original values.
7. This thresholded slice image is added to a cumulative image that is being built up for the basis weight image.
8. This thresholded slice image is compared to a cumulative image that is being built up for the top layer. Each pixel in the top layer image is examined:
a. If the top layer image is zero at a pixel, and the slice image pixel is above the threshold, then the top layer pixel value is set to the slice number.
b. If the top layer image pixel already has a value (i.e., from a prior slice) the pixel value is not changed. Without wishing to be limited by theory, it is thought that in doing so, the top layer image can record the slice level at which material first appeared. For example, if a top layer pixel is 0, and the slice image pixel is above the threshold, and we are at slice #74 then the pixel value will be set to 74.
9. For the bottom layer image, the image must already have a pixel set in the top layer image before we can set the bottom layer elevation. The threshold slice image is also compared to a cumulative image that is being built up for the top layer. Each pixel in the top layer image is examined:
a. If the top layer image is zero at a pixel, and the slice image pixel is above the threshold, then the pixel value of the bottom layer is left at 0.
b. If the top layer image pixel already has a value (meaning that we are now within the sample) the pixel value is set to the current slice number. For example if the top layer pixel value was 30 (material first appeared at slice 30), and we are at slice #93 then the bottom pixel value will be set to 93. It may continue to have the value (for this pixel column) incremented until we finally leave the material.
The bottom layer image will continue to have its pixels incremented as long as we are still within the material. In this way the bottom layer image can record the slice level at which material last appeared, and columns that had no material at all throughout the depth will have value 0.
10. Go back to step 4 and repeat until we have reached the ending slice as specified in step 2.
11. The thickness image is determined by subtracting the top layer image (Step 8) from the bottom layer image (Step 9).
12. The basis weight image is determined by multiplying the image by the slope value and adding the offset value, as specified by the calibration inputs (Step 4). If the user left the default values of 1 for the slope and 0 for the offset, then the basis weight image pixel values will be reported as gray levels (which is the voxel value or intensity).
13. The volume density image is determined by dividing the basis weight image (Step 12) by the thickness image (Step 11).

### Image Analysis—Region of Interest Measurement

The user can then inspect sub-regions of the above 5 images:
1. The Basis Weight image
2. The Thickness image
3. The Top Layer image
4. The Bottom Layer image
5. The Volume Density image

This is done as follows:
1. The user can specify which one of the 5 images is displayed.
2. The user selects one of three radio buttons. These radio buttons can be given a label that describes the type of region, for example “Thick,” “Thin,” and “Transition.”
3. The user interactively draws a polygon onto the displayed image.
4. The program measures the mean and standard deviation for all 5 images within the polygon region the user drew.
5. The user can optionally add a comment into a text box that describes the regions just drawn
6. The user clicks a button and a line is added to a cumulative data file that contains the filename, the region type (from Step 2), the user's comment (Step 5), and the 5 means and 5 standard deviations (Step 4).
7. The program also copies the region the user drew to a cumulative image that stores all the regions of a particular type (Step 2) that the user drew.
8. The user can repeat Steps 1-7 for as many regions as desired.

The results for all the region measurements are in a comma separated variable (CSV) file that can be opened with Microsoft Excel or any text editor. The 5 resulting images and the cumulative sub-region images (up to 3 of them) can also be visualized.

All publications, patent applications, and issued patents mentioned herein are hereby incorporated in their entirety by reference. Citation of any reference is not an admission regarding any determination as to its availability as prior art to the claimed invention.

“Comprising,” as used herein, means the term “comprising” and can include “consisting of” and “consisting essentially of.”

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. A fibrous structure product having two or more plies, wherein said fibrous structure product comprises:
(a) a plurality of formed surface features;
(b) a Hand Protection Factor of greater than about 2×10⁻²; and
(c) a basis weight of less than about 32 lbs/3000 ft².

2. The fibrous structure product according to claim 1 wherein the basis weight is from about 20 lbs/3000 ft² to about 32 lbs/3000 ft².

3. The fibrous structure product according to claim 1 wherein the Hand Protection Factor is from about 2×10⁻² to about 3×10⁻².

4. A fibrous structure product having one ply, wherein said fibrous structure product comprises:
(a) a plurality of formed surface features;
(b) a Hand Protection Factor of greater than about 2×10⁻²; and
(c) a basis weight of greater than about 13 lbs/3000 ft².

5. The fibrous structure product according to claim 4 wherein the surface features are selected from the group consisting of: discontinuous and semicontinuous.

6. The fibrous structure product according to claim 4 wherein the basis weight is from about 16 lbs/3000 ft² to about 26 lbs/3000 ft².

7. A fibrous structure product having one or more plies, wherein said fibrous structure product comprises:
(a) a plurality of formed surface features; and
(b) a Resistance Factor of greater than about −0.20.

8. The fibrous structure product according to claim 7 wherein the Resistance Factor is greater than about −0.10.

9. The fibrous structure product according to claim 7 wherein the Resistance Factor is from about −0.20 to 0.

10. The fibrous structure product according to claim 9 wherein the Resistance Factor is from about −0.10 to about 0.

11. A process for providing a fibrous structure product wherein the process comprises the steps of:
(a) providing a slurry wherein the slurry comprises from about 30 percent to about 100 percent by weight of NSK fibers;
and wherein the slurry comprises a pulp filtration resistance of from about 20° SR to about 28° SR;
(b) processing the slurry with a conventional through air dried papermaking apparatus, wherein the papermaking apparatus comprises a Fourdrinier wire and a carrier fabric; wherein the Fourdrinier wire is operating at a relatively slower speed than the carrier fabric.

12. The process according to claim 11 further comprising:
(c) a debonding agent.

13. The process according to claim 11 wherein the pulp filtration resistance is from about 23° SR to about 25° SR.

14. The process for providing a fibrous structure product according to claim 11 wherein the slurry comprises from about 40 percent to about 80 percent by weight of NSK fibers.

15. The process for providing a fibrous structure product according to claim 14 wherein the slurry comprises from about 50 percent to about 70 percent by weight of NSK fibers.

16. The process for providing a fibrous structure product according to claim 11 wherein the speed of the Fourdrinier wire is from about 0% to about −6% the speed of the carrier fabric.

17. A fibrous structure product comprising a plurality of formed features, wherein the formed features comprise a pillow region, a knuckle region, and a transition zone;
wherein the transition zone comprises a transition zone thickness and wherein the pillow region comprises a pillow region thickness;
wherein the transition zone thickness is from about 60 μm to about 120 μm; and
wherein the ratio of the transition zone thickness to the pillow region thickness is greater than about 0.8.

18. The fibrous structure product according to claim 17 wherein the ratio of the transition zone thickness to the pillow region thickness is from about 0.8 to about 1.2.

19. The fibrous structure product according to claim 18 wherein the ratio of the transition zone thickness to the pillow region thickness is from about 0.8 to about 1.0.

20. A fibrous structure product according to claim 17 wherein fibrous structure product comprises a basis weight of from about 10 lbs/3000 ft² to about 32 lbs/3000 ft².
